(19) United States
(12) Patent Application Publication
(10) Pub. No.: US 2026/0134499 A1
(43) Pub. Date: May 14, 2026

(54) Geometric Baking Cache System In Universal Scene Description Framework

(71) Applicant: Good Creative, LLC, Bloomfield Hills, MI (US)

(72) Inventor: Christopher WIRTH, Royal Oak, MI (US)

(73) Assignee: Good Creative, LLC, Bloomfield Hills, MI (US)

(21) Appl. No.: 19/384,582

(22) Filed: Nov. 10, 2025

Related U.S. Application Data
(60) Provisional application No. 63/719,188, filed on Nov. 12, 2024.

(51) Int. Cl. G06T 1/60; G06F 12/0802

(52) U.S. Cl. CPC G06T 1/60; G06F 12/0802; G06F 2212/455; G06F 2212/608

(57) ABSTRACT

The present application relates to the field of computer graphics animation, and more particular to a system and method for geometric cache optimization. One aspect of the present invention relates to a method for optimizing a geometric data cache. The method comprises importing geometric data into a Universal Scene Description framework, applying an advanced compression algorithm to the geometric data cache, indexing the compressed geometric data, selecting a portion of the compressed geometric data for decompression, and decompressing the compressed geometric data.

### CROSS-REFERENCE TO RELATED APPLICATIONS

This application claims priority to and the benefit of U.S. Provisional Application No. 63/719,188 filed on Nov. 12, 2024. The disclosure of the above application is incorporated herein by reference.

### FIELD

The present disclosure relates to the field of computer graphics animation, and more particular to a system and method for geometric cache optimization.

### BACKGROUND

This section provides background information related to the present disclosure which is not necessarily prior art.

The management and processing of geometric data are critical to the creation of high-quality visual content, particularly in computer-generated imagery (CGI) and real-time rendering applications. Geometric data typically consists of complex, multi-dimensional representations of objects, including their shapes, surfaces, and spatial relationships within a digital scene. This data is essential for accurately rendering scenes with a high level of detail, making it a cornerstone of modern visual effects, animation, and interactive media.

To efficiently manage and access this geometric data, especially in large-scale projects, geometric data caching systems have been developed. These systems store precomputed geometric data that can be quickly retrieved and utilized during rendering, thereby reducing the computational load and improving the responsiveness of the application. However, geometric data often occupies vast amounts of storage storage space when stored in an uncompressed form.

Accordingly, there is a need for improved systems and methods for caching geometric data.

### SUMMARY

This section provides a general summary of the disclosure and is not a comprehensive disclosure of its full scope or all of its features.

The present disclosure is defined in the appended independent claims. Advantageous embodiments of the invention are defined in the dependent claims.

According to a first aspect of the present disclosure, a method for optimizing a geometric data cache, the method including: importing geometric data into a Universal Scene Description framework; applying an advanced compression algorithm to the geometric data cache; indexing the compressed geometric data; selecting a portion of the compressed geometric data for decompression; and decompressing the compressed geometric data.

According to the first aspect, the geometric data includes at least one of vertices, edges, polygons, normals, textures, UV coordinates, and transformations.

According to the first aspect, the advanced compression algorithm includes at least one of the following techniques: delta encoding, quantization, and spatial data clustering.

According to the first aspect, the applying an advanced compression algorithm reduces the geometric data cache size by an amount such that a 75 GB cache is reduced to 5 GB.

According to the first aspect, the compressed geometric data is structured and stored within the Universal Scene Description data format.

According to the first aspect, decompressing the compressed geometric data is performed in real time.

According to the first aspect, including integrating the geometric data caching system into a rendering pipeline of graphics applications.

According to a second aspect of the present disclosure, a method for importing and converting a low-quality rig to a high-quality rig, the method including: importing animation data for the low-quality rig into a Universal Scene Description framework; analyzing the imported animation data to determine transfer compatibility and identifying the high-quality rig's corresponding elements; mapping the animation data from the low-quality rig to the high-quality rig's corresponding elements, including matching bones, joints, and other relevant components; applying advanced interpolation and adjustment algorithms to ensure the animation data adheres to the higher fidelity standards required by the high-quality rig; and storing the mapped animation data for the high-quality rig into the USD framework.

According to the second aspect, the animation data includes data for controlling movement and deformation of a character model.

According to the second aspect, the low-quality rig is a simplified version with fewer elements than the high-quality rig.

According to the second aspect, the analyzing step is performed to overcome the need for an animator to perform the transfer through manual adjustments and re-rigging.

According to the second aspect, including making real-time adjustments and fine-tuning of the transformed animation data.

According to the second aspect, the high-quality rig is used for final rendering and production.

According to a third aspect of the present disclosure, a method for binding meshes to cached geometry, the method including: importing mesh data into the Universal Scene Description framework; initializing a proxy system to prepare for binding; mapping each point on the imported mesh data to corresponding points on a cached geometry; applying advanced binding algorithms to ensure accurate and efficient binding of the imported mesh data to the cached geometry; enabling dynamic adjustments to allow real-time updates and modifications to the imported mesh data; storing the imported mesh data in the USD framework; and generating a final output ready for use in real-time applications.

According to the third aspect, the mesh data includes at least one of hair, fur, and curves.

According to the third aspect, the method is performed by a proxy point-to-point curves and mesh binding tool.

According to the third aspect, the mapping each point step is a point-to-point mapping.

According to the third aspect, the binding is performed to ensure that as the underlying cached geometry moves or deforms, the imported mesh data follows appropriately.

According to the third aspect, the enabling dynamic adjustments step allows the method to be used in real-time binding operations.

According to the third aspect, the generating a final output step includes generating an output ready for use in a real-time application.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

In order to best describe the manner in which the above-described embodiments are implemented, as well as define other advantages and features of the disclosure, a more particular description is provided below and is illustrated in the appended drawings. Understanding that these drawings depict only exemplary embodiments of the invention and are not therefore to be considered to be limiting in scope, the examples will be described and explained with additional specificity and detail through the use of the accompanying drawings in which:

FIG. 1 is a flow chart of a method of optimizing a geometric data cache in a geometric data caching system.

FIG. 2 is a flow chart of a method for importing and converting a low-quality rig to a high-quality rig by a low-quality rig to high-quality rig importing tool.

FIG. 3 is a flow chart of a method for binding meshes, hair, fur, and curves to cached geometry within the USD framework using a proxy point-to-point curves and mesh binding tool is shown.

FIG. 4 is a flow chart of a method for real-time conversion of audio into facial animations and gestures within the Omniverse platform by the A2F and A2G extensions

FIG. 5 is a flow chart of a method for baking UV coordinates to curves within the USD framework by a UV coordinates to curves coordinates tool.

Corresponding reference numerals indicate corresponding parts throughout the several views of the drawings.

### DETAILED DESCRIPTION

Example embodiments will now be described more fully with reference to the accompanying drawings.

Various embodiments of the disclosed methods and arrangements are discussed in detail below. While specific implementations are discussed, it should be understood that this is done for illustration purposes only. A person skilled in the relevant art will recognize that other components, configurations, and steps may be used without parting from the scope of the disclosure.

Geometric data typically consists of complex, multi-dimensional representations of objects, including their shapes, surfaces, and spatial relationships within a digital scene. Geometric data may include vertices, edges, polygons, normals, textures, UV coordinates, and transformations. Vertices are points in 3D space that define the corners or intersections of geometric shapes. Edges are lines connecting vertices, representing the boundaries of geometric shapes. Polygons are flat surfaces bounded by edges, usually, but not limited to, forming triangles or quadrilaterals, which together make up the surface of a 3D object. Normals are vectors perpendicular to faces, used to determine how light interacts with surfaces, essential for shading and rendering. Textures are mappings of 2D images, typically referred to as textures, onto the 3D surface of objects, using UV coordinates to position the texture correctly. Transformations are information about the position, rotation, and scaling of objects in the 3D space, often relative to other objects in the scene or the scene as a whole. Geometric data is essential for accurately rendering scenes with a high level of detail.

To efficiently manage and access this geometric data, especially in large-scale projects, geometric data caching systems have been developed. These systems store precomputed geometric data that can be quickly retrieved and utilized during 3D rendering and CGI applications, thereby reducing the computational load and improving the responsiveness of the application. A geometric data cache may reduce the need to reprocess or re-fetch geometric data during rendering. To manage the large volume of geometric data, a geometric data caching system may employ compression algorithms to reduce the size of the data stored in the cache. Further, the geometric data caching system may be integrated into the rendering pipeline of graphics applications so that, as scenes are rendered, the necessary geometric data is readily available, thereby avoiding bottlenecks that could occur if the data had to be recomputed or retrieved from slower storage systems.

The Universal Scene Description (USD) framework is an advanced, open-source software platform developed by Pixar Animation Studios, designed for the robust interchange, collaborative editing, and non-destructive composition of highly complex 3D scene data. The USD framework provides for representing hierarchical scene graphs, including geometric, shading, lighting, and material data, alongside other essential scene attributes such as animation and metadata. The USD framework further provides for a flexible and extensible schema.

The USD framework is intended to handle large-scale, intricate scenes composed of numerous assets, each of which may be independently authored, modified, and updated without disrupting the overall scene integrity. This is due to the USD framework's non-destructive layer-based composition model, which allows for the incremental assembly of scenes from multiple sources, maintaining version control and seamless collaboration across teams.

The USD framework's scene description files are serialized in a compact, binary format designed for rapid I/O operations for real-time applications.

The USD framework is extensible and interoperable, supporting a wide array of industry-standard file formats and integrating with existing content creation tools, such as Autodesk Maya, Houdini, and others. Through its plug-in architecture, the USD framework can be adapted and extended to meet the specific needs of various production pipelines, providing a versatile foundation for both the development and deployment of 3D content across multiple platforms.

### Geometric Baking Cache System in Universal Scene Description Framework

Geometric data typically consists of complex, multi-dimensional representations of objects, including their shapes, surfaces, and spatial relationships within a digital scene. Geometric data may include vertices, edges, polygons, normals, textures, UV coordinates, and transformations. Vertices are points in 3D space that define the corners or intersections of geometric shapes. Edges are lines connecting vertices, representing the boundaries of geometric shapes. Polygons are flat surfaces bounded by edges, usually, but not limited to, forming triangles or quadrilaterals, which together make up the surface of a 3D object. Normals are vectors perpendicular to faces, used to determine how light interacts with surfaces, essential for shading and rendering. Textures are mappings of 2D images, typically referred to as textures, onto the 3D surface of objects, using UV coordinates to position the texture correctly. Transformations are information about the position, rotation, and scaling of objects in the 3D space, often relative to other objects in the scene or the scene as a whole. Geometric data is essential for accurately rendering scenes with a high level of detail.

To efficiently manage and access this geometric data, especially in large-scale projects, geometric data caching systems have been developed. These systems store precomputed geometric data that can be quickly retrieved and utilized during 3D rendering and CGI applications, thereby reducing the computational load and improving the responsiveness of the application. A geometric data cache may reduce the need to reprocess or re-fetch geometric data during rendering. To manage the large volume of geometric data, a geometric data caching system may employ compression algorithms to reduce the size of the data stored in the cache. Further, the geometric data caching system may be integrated into the rendering pipeline of graphics applications so that, as scenes are rendered, the necessary geometric data is readily available, thereby avoiding bottlenecks that could occur if the data had to be recomputed or retrieved from slower storage systems.

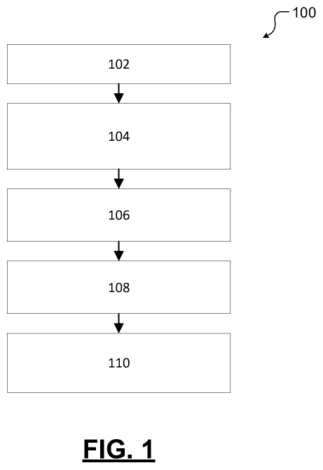

With reference to FIG. 1, a method 100 for optimizing a geometric data cache in a geometric data caching system is shown.

In step 102, geometric data may be imported into the USD framework. The system may use only the selected geometric data to identify the only geo needed to achieve point-to-point binding.

In step 104, the system may apply an advanced compression algorithm to the geometric data cache. The advanced compression algorithm may reduce significantly reduce the size of the geometric cache. In one example, the advanced compression algorithm may reduce the geometric cache size from 75 GB to 5 GB. The advanced compression algorithm may apply techniques such as delta encoding, quantization, and spatial data clustering. The compressed geometric date may be structured and stored within the Universal Scene Description data format.

In step 106, the system may index the compressed geometric data to facilitate quick retrieval and reconstruction of the compressed geometric data.

In step 108, a portion of the compressed geometric data may be selected for decompression.

In step 110, the system may decompress the compressed geometric data. The decompression of the compressed geometric data may be performed “on the fly.”

### Low-Quality Rig to High-Quality Rig Tool

Animation rigging, or “rigging,” involves constructing a skeletal structure, often referred to as a “rig,” that controls the movement and deformation of a character model. This rig is used by animators to create lifelike animations by manipulating the bones, joints, and other control points of the model. In many production environments, it is common to employ both low-quality rigs, which are simplified versions with fewer elements used for initial animation work, and high-quality rigs, which are fully detailed, include a greater number of elements, and are used for final rendering and production.

Transferring animation data from low-quality rigs to high-quality rigs presents challenges. Typically, low-quality rigs are used during the early stages of animation to allow for faster and more responsive manipulation. These rigs are often less detailed and may lack the full range of controls present in high-quality rigs. Once the animation is finalized on a low-quality rig, the data must be transferred to a high-quality rig, which is necessary for achieving the level of detail and realism required in final production. This transfer is commonly made by an animator through manual adjustments and re-rigging. This process is time-consuming, prone to human error, and can introduce inconsistencies and inaccuracies in the final animation.

Further, existing solutions often require the data to be exported, modified, and then re-imported, which introduces delays and disrupts the animation workflow. These delays are particularly problematic in real-time environments, such as video games or virtual production, where responsiveness and efficiency are crucial.

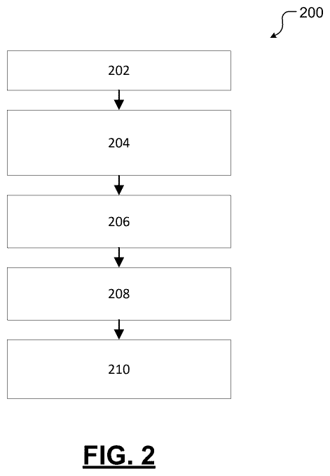

With reference to FIG. 2, a method 200 for importing and converting a low-quality rig to a high-quality rig by a low-quality rig to high-quality rig importing tool is shown.

In step 202, the tool may import animation data for a low-quality rig into the USD framework.

In step 204, the tool may analyze the imported animation data to determine transfer compatibility and identify the high-quality rig's corresponding elements.

In step 206, the tool may map the animation data from the low-quality rig to the high-quality rig's corresponding elements, including matching bones, joints, and other relevant components.

In step 208, the tool may apply advanced interpolation and adjustment algorithms to ensure the animation data adheres to the higher fidelity standards required by the high-quality rig.

In step 210, the tool may store the mapped animation data for the high-quality rig into the USD framework.

The tool may further be used to make real-time adjustments and fine-tuning of the transformed animation data.

### Proxy Point-to-Point Curves and Mesh Binding Tool

Binding meshes, hair, fur, and curves to underlying geometry is crucial for achieving realistic visual effects. This process involves attaching, or “binding,” these elements, which are often complex and highly detailed, to a base geometric structure that serves as their foundation within a scene. This binding must be precise and stable to ensure that as the underlying geometry moves or deforms, the attached elements follow appropriately, maintaining their intended appearance and behavior.

Traditionally, the process of binding these elements to geometry has been labor-intensive, often requiring manual adjustments by animators. This manual binding is prone to errors and inconsistencies, especially in complex scenes where high fidelity and accuracy are required. Such manual processes are also time-consuming, leading to inefficiencies in the production pipeline, particularly in large-scale projects where thousands of elements may need to be accurately bound.

Moreover, existing systems generally lack support for real-time binding operations. Traditional binding methods are typically performed offline, meaning that adjustments and bindings are calculated in advance and then applied during rendering. This offline approach can cause workflow delays, as any changes to the geometry or the bound elements necessitate a re-calculation and re-binding process. This lack of real-time capability hinders productivity, especially in environments where iterative design and rapid feedback are essential.

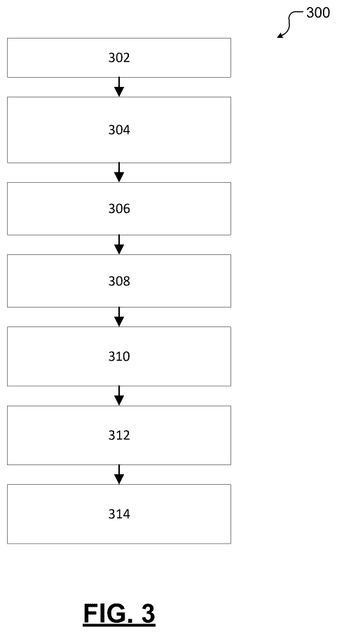

With reference to FIG. 3, a method 300 for binding meshes, such as hair, fur, and curves, to cached geometry within the USD framework using a proxy point-to-point curves and mesh binding tool is shown.

In step 302, the tool may import geometric data, including meshes, hair, fur, and curves, into the USD framework.

In step 304, the tool may initialize the proxy system to prepare for binding.

In step 306, the tool may map each point on the meshes, hair, fur, and curves to corresponding points on the cached geometry.

In step 308, the tool may apply advanced binding algorithms to ensure that the meshes, hair, fur, and curves are accurately and efficiently bound to the cached geometry.

In step 310, the tool may enable dynamic adjustments, allowing real-time updates and modifications to the bound elements.

In step 312, the tool may store the bound meshes, hair, fur, and curves into the USD framework.

In step 314, the tool may generate a final output, ready for use in real-time applications.

### Audio-to-Facial (A2F) and Audio-to-Gesture (A2G) Extension in Omniverse

The generation of realistic facial expressions and gestures from audio is a critical component of creating lifelike characters in animated films, video games, virtual reality, and other interactive media. Traditionally, the creation of facial expressions and gestures synchronized with audio has been a labor-intensive and time-consuming task, often requiring skilled animators to manually keyframe each expression and movement. Automated tools may be used to address the inefficiencies of manual animation, including phoneme-based lip-syncing tools, which map phonetic elements of speech to corresponding mouth shapes, and gesture recognition systems, which analyze audio for cues that can be translated into body movements. However, these tools often operate as external applications, requiring separate workflows that must be integrated into larger production pipelines. This separation introduces additional complexity and potential compatibility issues, particularly when integrating with platforms like Nvidia's Omniverse, a collaborative platform for 3D simulation and design.

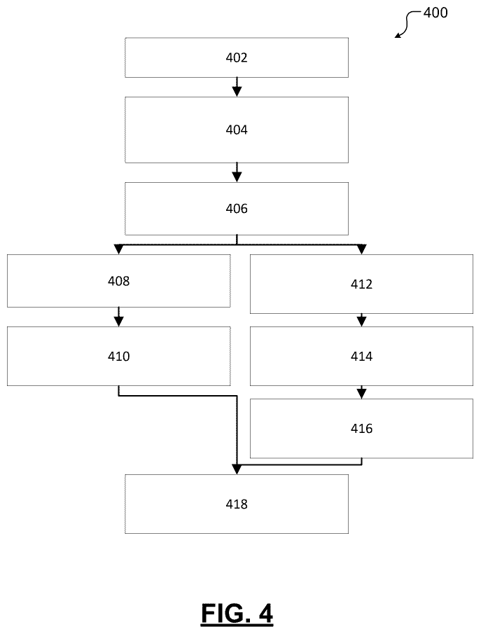

With reference to FIG. 4, a method 400 for real-time conversion of audio into facial animations and gestures within the Omniverse platform by the A2F and A2G extensions. Steps 402-406 and 418 may be performed by both the A2F and A2G extensions. Steps 408-410 may be performed by the A2F extension. Steps 412-416 may be performed by the A2G extension.

In step 402, the A2F and/or A2G extensions may import audio data into the Omniverse platform.

In step 404, the A2F and/or A2G extensions may analyze the imported audio to identify key phonetic and emotional elements. This process may be integrated within the Animation tool on the Omniverse platform.

In step 406, the A2F and/or A2G extensions may map phonetic elements from the imported audio to corresponding facial expressions and movements. As in step 404, This process may be integrated within the Animation tool on the Omniverse platform.

In step 408, the A2F extension may detect emotional cues from the imported audio and map them to facial expressions. As in previous steps, this process may be integrated within the Animation tool on the Omniverse platform.

In step 410, the A2F extension may generate real-time facial animations based on the mapped phonemes and emotions. As in previous steps, this process may be integrated within the Animation tool on the Omniverse platform.

In step 412, the A2G extension may map audio cues to corresponding gestures, such as hand movements and body language. As in previous steps, this process may be integrated within the Animation tool on the Omniverse platform.

In step 414, the A2G extension may synchronize gestures with the imported audio to ensure natural and coherent animations.

In step 416, the A2G extension may generate real-time gesture animations based on the mapped audio cues.

In step 418, the A2F and/or A2G extensions may integrate the generated facial and gesture animations into the Omniverse platform.

### UV Coordinates to Curves Coordinates Tool

UV mapping is a process that involves projecting a 2D texture onto a 3D model's surface, where UV coordinates define how the texture aligns with the model's geometry. UV coordinates determine the appearance and detail of textures on complex models, particularly in scenarios involving curved surfaces and intricate geometries. Accurately mapping UV coordinates to curves, and subsequently converting these mappings into usable formats within production frameworks, is essential for achieving high-quality visual results, especially in fields like animation, gaming, and visual effects.

Typically, animators and artists must manually adjust UV mappings and ensure that they align correctly with the curved geometries. This manual process is not only labor-intensive but also highly error-prone, leading to inconsistencies in the final output and significant delays in production timelines.

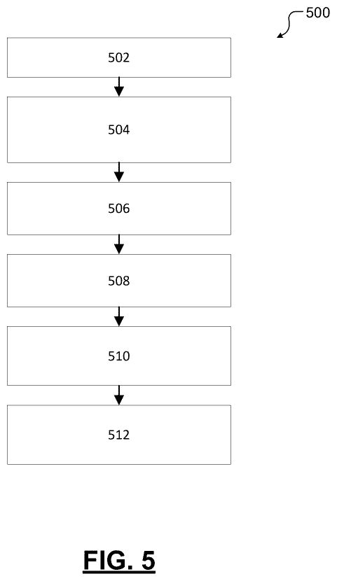

With reference to FIG. 5, a method 500 for baking UV coordinates to curves within the USD framework by a UV coordinates to curves coordinates tool.

In step 502, the tool may import UV coordinates data and curve data into the USD framework. The UV data and coordinates may be derived from 3D creation software, such as Blender, Maya, or other 3D software.

In step 504, the tool may analyze the imported UV coordinates and curve data to prepare for baking.

In step 506, the tool may map the UV coordinates data onto the curves coordinates data.

In step 508, the tool may apply advanced baking algorithms to convert the UV-mapped curves into cords within the USD framework.

In step 510, the tool may store the baked UV to curves cords into the USD framework.

In step 512, the tool may optimize the storage of the baked UV to curves cords to facilitate quick retrieval and efficient use in real-time applications.

The foregoing description of the embodiments has been provided for purposes of illustration and description and is not intended to be exhaustive or to limit the disclosure. Individual elements or features of a particular embodiment are generally not limited to that particular embodiment, but, where applicable, are interchangeable and can be used in another embodiment, even if not specifically shown or described. The various embodiments may also be varied in many ways. Such variations are not to be regarded as a departure from the disclosure, and all such modifications are intended to be included within the scope of the disclosure. Although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Example embodiments are provided so that this disclosure will be thorough and will fully convey the scope to those who are skilled in the art. Specific details are set forth, including examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

In the written description and claims, one or more steps within a method may be executed in a different order (or concurrently) without altering the principles of the present disclosure. Similarly, one or more instructions stored in a non-transitory computer-readable medium may be executed in different order (or concurrently) without altering the principles of the present disclosure. Unless indicated otherwise, numbering or other labeling of instructions or method steps is done for convenient reference and not to indicate a fixed order.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

The phrase “at least one of A, B, and C” should be construed to mean a logical (A OR B OR C), using a non-exclusive logical OR, and should not be construed to mean “at least one of A, at least one of B, and at least one of C.” The term “set” does not necessarily exclude the empty set. The term “non-empty set” may be used to indicate exclusion of the empty set. The term “subset” does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard (including Core Specification versions 3.0, 4.0, 4.1, 4.2, 5.0, and 5.1 from the Bluetooth SIG) from the Bluetooth Special Interest Group (SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media.

The apparatuses and methods described in this application may be partially or fully implemented by a special purpose computer created by configuring a general purpose computer to execute one or more particular functions embodied in computer programs. Such apparatuses and methods may be described as computerized apparatuses and computerized methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The various embodiments described above are provided by way of illustration only and should not be construed to limit the invention. Those skilled in the art will readily recognize various modifications and changes that may be made to the present invention without following the example embodiments and applications illustrated and described herein, and without departing from the scope of the present disclosure.

What is claimed is:

1. A method for optimizing a geometric data cache, the method comprising:
importing geometric data into a Universal Scene Description framework;
applying an advanced compression algorithm to the geometric data cache;
indexing the compressed geometric data;
selecting a portion of the compressed geometric data for decompression; and
decompressing the compressed geometric data.

2. The method of claim 1, wherein the geometric data includes at least one of vertices, edges, polygons, normals, textures, UV coordinates, and transformations.

3. The method of claim 1, wherein the advanced compression algorithm includes at least one of the following techniques: delta encoding, quantization, and spatial data clustering.

4. The method of claim 1, wherein the applying an advanced compression algorithm reduces the geometric data cache size by an amount such that a 75 GB cache is reduced to 5 GB.

5. The method of claim 1, wherein the compressed geometric data is structured and stored within the Universal Scene Description data format.

6. The method of claim 1, wherein decompressing the compressed geometric data is performed in real time.

7. The method of claim 1, further comprising integrating the geometric data caching system into a rendering pipeline of graphics applications.

8. A method for importing and converting a low-quality rig to a high-quality rig, the method comprising:
importing animation data for the low-quality rig into a Universal Scene Description framework;
analyzing the imported animation data to determine transfer compatibility and identifying the high-quality rig's corresponding elements;
mapping the animation data from the low-quality rig to the high-quality rig's corresponding elements, including matching bones, joints, and other relevant components;
applying advanced interpolation and adjustment algorithms to ensure the animation data adheres to the higher fidelity standards required by the high-quality rig; and
storing the mapped animation data for the high-quality rig into the USD framework.

9. The method of claim 8, wherein the animation data comprises data for controlling movement and deformation of a character model.

10. The method of claim 8, wherein the low-quality rig is a simplified version with fewer elements than the high-quality rig.

11. The method of claim 8, wherein the analyzing step is performed to overcome the need for an animator to perform the transfer through manual adjustments and re-rigging.

12. The method of claim 8, further comprising making real-time adjustments and fine-tuning of the transformed animation data.

13. The method of claim 8, wherein the high-quality rig is used for final rendering and production.

14. A method for binding meshes to cached geometry, the method comprising:
importing mesh data into the Universal Scene Description framework;
initializing a proxy system to prepare for binding;
mapping each point on the imported mesh data to corresponding points on a cached geometry;
applying advanced binding algorithms to ensure accurate and efficient binding of the imported mesh data to the cached geometry;
enabling dynamic adjustments to allow real-time updates and modifications to the imported mesh data;
storing the imported mesh data in the USD framework; and
generating a final output ready for use in real-time applications.

15. The method of claim 14, wherein the mesh data includes at least one of hair, fur, and curves.

16. The method of claim 14, wherein the method is performed by a proxy point-to-point curves and mesh binding tool.

17. The method of claim 14, wherein the mapping each point step is a point-to-point mapping.

18. The method of claim 14, wherein the binding is performed to ensure that as the underlying cached geometry moves or deforms, the imported mesh data follows appropriately.

19. The method of claim 14, wherein the enabling dynamic adjustments step allows the method to be used in real-time binding operations.

20. The method of claim 14, wherein the generating a final output step comprises generating an output ready for use in a real-time application.
